(19) United States
(12) Patent Application Publication
(10) Pub. No.: US 2009/0278480 A1
(43) Pub. Date: Nov. 12, 2009

(54) Aircraft simulating Lighting fixture

(76) Inventor: Brendon Nunes, Ajax (CA)

Correspondence Address: ROBERT A. VANDERHYE, 801 RIDGE DR., MCLEAN, VA, 22101-1625, US

(21) Appl. No.: 12/387,524

(22) Filed: May 4, 2009

Related U.S. Application Data
(60) Provisional application No. 61/071,615, filed on May 8, 2008.

(51) Int. Cl. H05B 37/02; F21V 21/00; F21S 4/00; F21V 9/00; A61G 13/00; F21V 33/00

(52) U.S. Cl. 315/362; 362/227; 362/249.02; 362/231; 362/33; 362/234

(57) ABSTRACT

A light fixture is provided which is in the form of a simulated aircraft, preferably simulating as accurately as practical a particular known, existing, actual aircraft, such as a military jet, commercial jet, commercial propeller plane, military or civilian helicopter, glider, ultralight, hang glider, or drone. The simulated aircraft has at least one primary light source (e. g. a white LED) which performs a volume lighting function, and at least one secondary light source which performs an aesthetic, educational, and/or nightlight function (e. g. a red LED simulating a jet afterburner). The simulated aircraft may be mounted on a support shaft which extends to a base, which in turn mounts various electrical components, and may have associated indicia which simulates a cockpit control panel. The cockpit-simulating indicia may be backlit to provide an aesthetic function, for providing an educational function, and/or for providing a nightlight function, or a digital photo frame could be provided. The base may include one or more actual functioning instruments (e. g. a clock and compass).

### CROSS REFERENCE TO RELATED APPLICATION

This application claims priority of U.S. Provisional Application Ser. No. 61/071,615 filed May 8, 2008.

### BACKGROUND AND SUMMARY OF THE INVENTION

In the lighting fixture art, it is often desirable to have a lighting fixture that not only serves the purpose of lighting a particular volume, but also provides a “statement” function, or to serve as a novelty item, a toy, an educational purpose, and/or as an aesthetic object. According to the invention a lighting fixture is provided—such as in the form of a desk lamp—which performs a number of other functions besides simply lighting a particular volume. A lighting fixture according to the invention can provide an educational function, can serve as a desk lamp and a night light, can function as a toy, can include an actual functioning instrument (such as a clock or compass), and/or provides a “statement” about the owner of the desk lamp.

According to the present invention a light fixture is provided which is in the form of a simulated aircraft, preferably simulating as accurately as practical a particular known, existing, actual aircraft, such as a military jet (e. g. F-18, or as illustrated in U S D 358,432), commercial jet (e. g. Boeing 727), commercial propeller plane (e. g. a Piper Cub, or as illustrated in U S D 585,666), military or civilian helicopter (such as in U S D 583,879 or D 532,096), glider, ultralight, hang glider, drone (such as the MQ-1 Predator unmanned military aircraft), or the like. The simulated aircraft has at least one primary light source which performs a “volume lighting” function, that is providing enough light for someone with normal vision to see clearly in the volume illuminated. The simulated aircraft includes at least one secondary light source which performs an aesthetic, educational, and/or nightlight function.

In a preferred embodiment, the simulated aircraft is mounted on a support shaft which extends to a base (that is a desk lamp or the like may be provided). The base mounts various electrical components, and additionally preferably has indicia associated therewith which simulates the control panel in the cockpit of an actual aircraft corresponding to the simulated aircraft. The cockpit-simulating indicia are preferably backlit to provide an aesthetic function, for providing an educational function, and/or for providing a nightlight function. The backlighting for the cockpit-simulating indicia may be provided by a light emitting diode or an electroluminescent panel. The base may further comprises a heads-up display and include an electrical switch controlling all light sources associated with the lighting fixture.

As an alternative, the base may comprise a digital photo frame which can display a number of different digital photos (including in a slide show or movie format) viewable when viewing said base.

Alternatively, instead of a desk lamp, the invention may comprise a sconce, hanging light fixture, or the like.

While any light sources (e. g. halogen, incandescent) can be used in association with the invention, preferably the light sources are light emitting diodes. LEDs have a number of advantages, including low power consumption, long life, and little heat that requires dissipation. That allows a number of the component parts—including the simulated aircraft itself—to be made of plastic without creating a potential fire hazard.

In the invention, the primary light source may primarily emit a white light, and at least one secondary light source emits a color other than white, such as red. The at least one secondary light source may comprise a first secondary light source illuminating a simulated cockpit of the simulated aircraft, and a second secondary light source simulating a jet engine afterburner (e. g. with a red or orange LED).

According to another aspect of the invention, there is provided a desk lamp comprising a simulated aircraft having at least one primary light source which performs a volume lighting function, a lamp base, and a support operatively connecting the lamp-base to the simulated aircraft, electrical power for lighting the at least one primary light source being provided from the lamp base through the support to the simulated aircraft. The lamp base may include the other modifications and additions as set forth above.

Still further, the lamp base may comprise at least one actual functioning instrument, for example at least one instrument selected from one or more of a clock, barometer, thermometer, inclinometer, compass, and altimeter. A single instrument may be provided, or a plurality of instruments may be provided in a cluster, or different individual instruments may be visible when looking at the base from different directions.

It is the primary object of the present invention to provide a novel and functional lighting fixture simulating an aircraft. This and other objects will be apparent from the detailed description of the invention, and from the appended claims.

### BRIEF DESCRIPTION OF THE DRAWINGS

FIG. 1 is a schematic perspective illustration of an exemplary desk lamp according to the present invention showing a simulated aircraft in the form of a military jet, a base, and a flexible support between the simulated aircraft and base;

FIG. 2 is a front view of the simulated aircraft in FIG. 1, and a part of the support;

FIGS. 3, 4, 5, and 6, are rear, side, top, and bottom views, respectively, of the simulated aircraft in FIGS. 1 and 2;

FIG. 7 is a side view, primarily in cross-section and partly in elevation, of one form of lamp base according to the invention for supporting and cooperating with the simulated aircraft in FIGS. 2 through 6;

FIG. 8 is a view like that of FIG. 7 of a modified embodiment of the lamp base; and

FIG. 9 is a view like that of FIG. 1 only showing a modified form of the invention wherein the base comprises an actual functioning instrument.

### DETAILED DESCRIPTION OF THE DRAWINGS

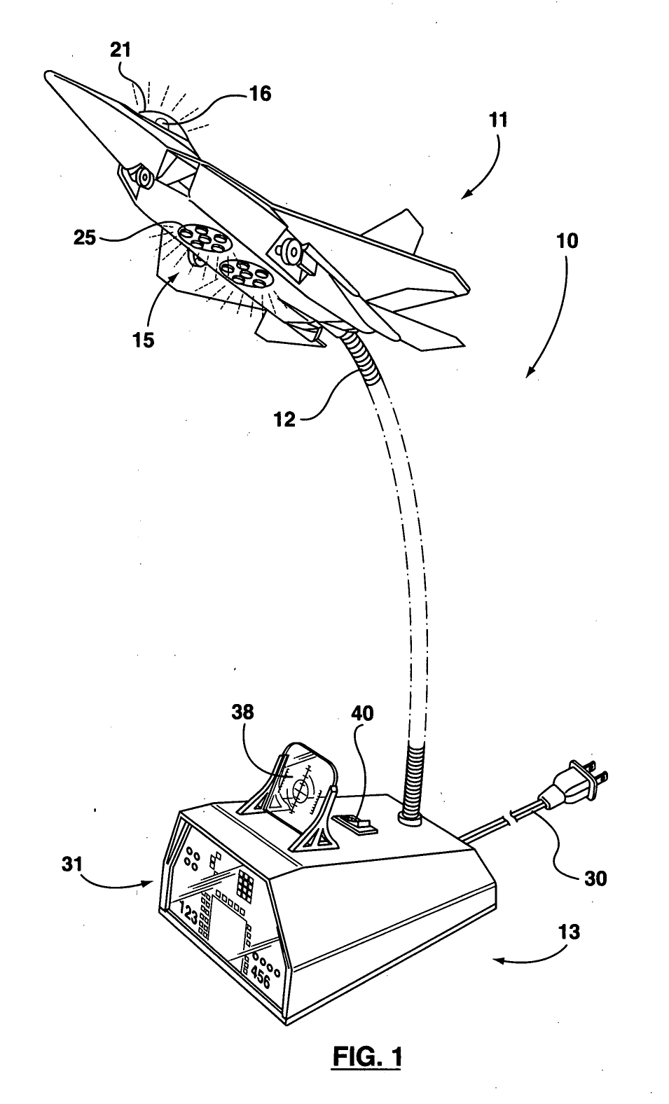

An exemplary lighting fixture according to the invention is shown generally by reference 10 in FIG. 1. Its main component is a simulated aircraft 11. While in the preferred form of the invention illustrated in the drawings the aircraft 11 is part of the desk lamp, in other embodiments of the invention the simulated aircraft can be distinct from a desk lamp. For example it may be part of a wall mounted light fixture, could be an entirely independent type of light fixture that has an internal power source so that it can be suspended from above (for example by a part of a ceiling, or a ceiling fan or light fixture), or it could function like a chandelier, or could have many other functions and configurations.

In the embodiment indicated by reference 10 in FIG. 1, the simulated aircraft 11 is supported by a conventional flexible support 12 (such as a “gooseneck”), and it is operatively connected to a lamp base 13. The base 13 (as will be hereinafter fully described) not only provides for mechanical support of the “gooseneck”, but also includes a number of electrical components as well as providing an educational, aesthetic, instrument, and/or night light function.

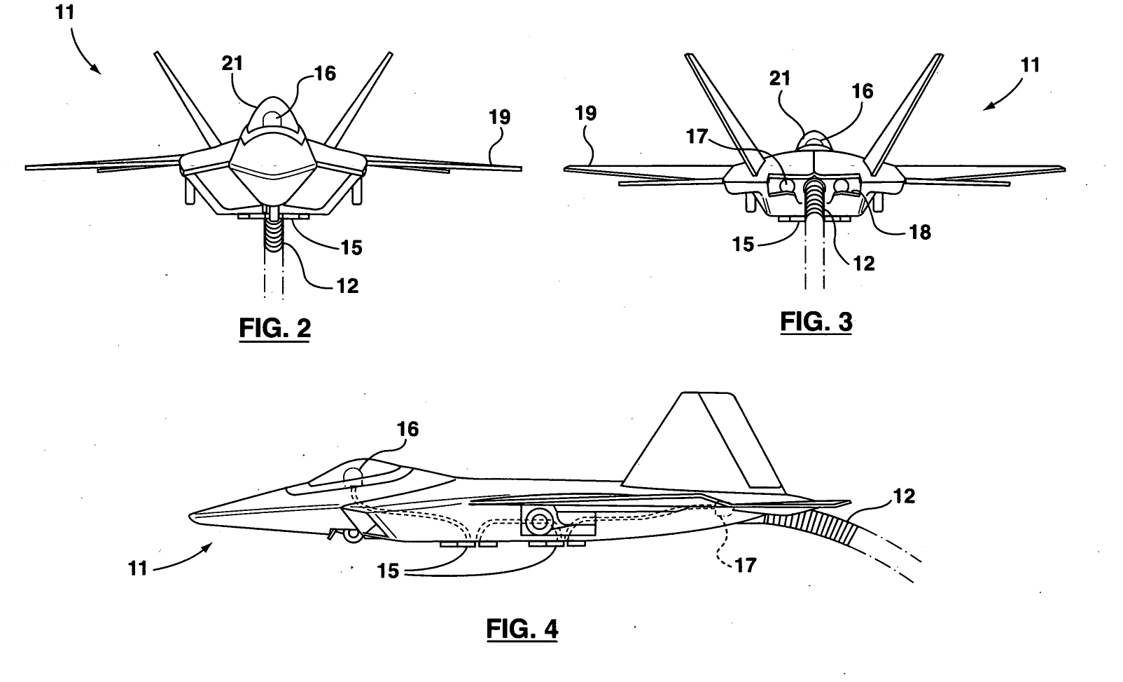

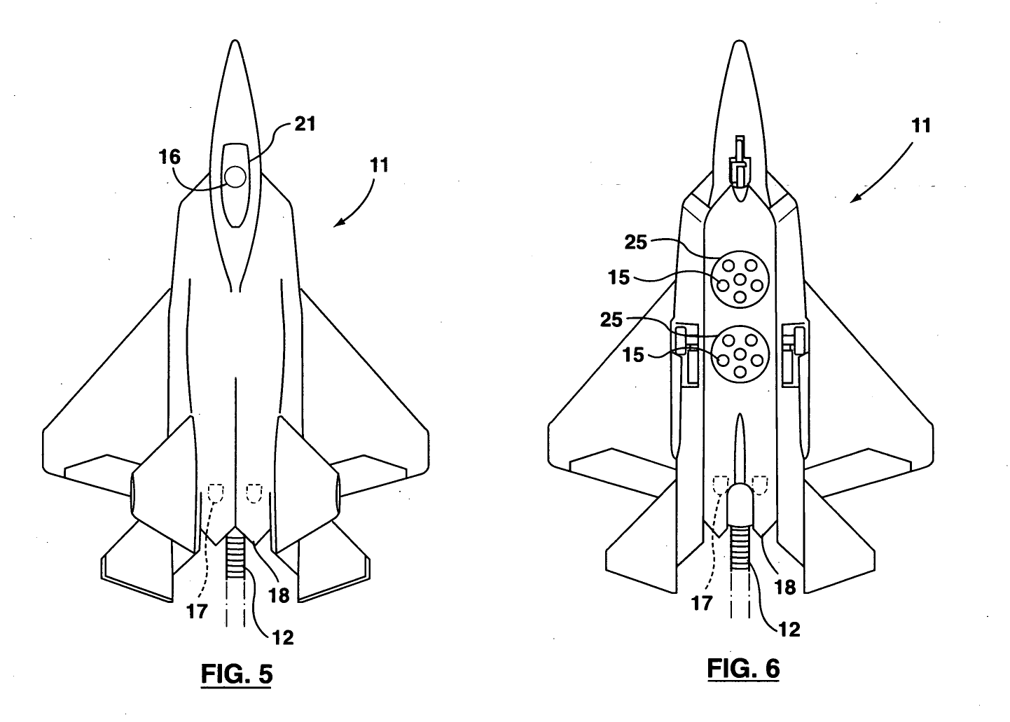

As will be seen in all of FIGS. 1 through 4 and 6, the simulated aircraft 11 has at least one primary light source 15 (two are shown in FIG. 1) which performs a “volume lighting” function, that is providing enough light for someone with normal vision to see clearly in the volume illuminated (for example a desktop). The simulated aircraft 11 also includes at least one secondary light source 16, 17, 18, 19, which performs an aesthetic, educational, and/or nightlight function. In the embodiment illustrated in FIGS. 1 through 6, the secondary light source 16 illuminates the simulated cockpit 21 of the aircraft 11, the secondary light sources 17, 18 simulate gases emitted from jet engines, and the secondary light source(s) 19 simulates a wingtip light source(s) of a conventional airplane. All of the light sources 15-19 may have different colors, depending upon the functions they serve. For example the primary light source 15 may be one or more white LEDs (e. g. 1-5 W). The “cockpit” light source 16 may be a very small green LED, the “afterburner” light sources 17, 18, may be small red or orange light emitting diodes, and the “wingtip” light sources 19 may be small white or yellow LEDs.

Because the primary light source 15 is preferably one that generates little waste heat, under some circumstances it may not require a heat sink. However in circumstances where it is desirable to have an abundance of caution (especially where the simulated aircraft 11 is primarily made of molded plastic), a heat sink is provided, seen schematically at 25 in FIGS. 1 and 6. For example (and example only) heat sink 25 may be a disc or toroid of aluminum two to three cm in diameter and one to two cm thick, with the light source 15 concentric with it and mounted in a central aperture(s) thereof. The heat sink 25 can have any useful shape.

Although it is preferred that the secondary light sources be individual light emitting diodes, of various colors, if the secondary sources do not provide a nightlight function, they may be provided by light piping from the primary light source 15, with different colored lenses (if desired).

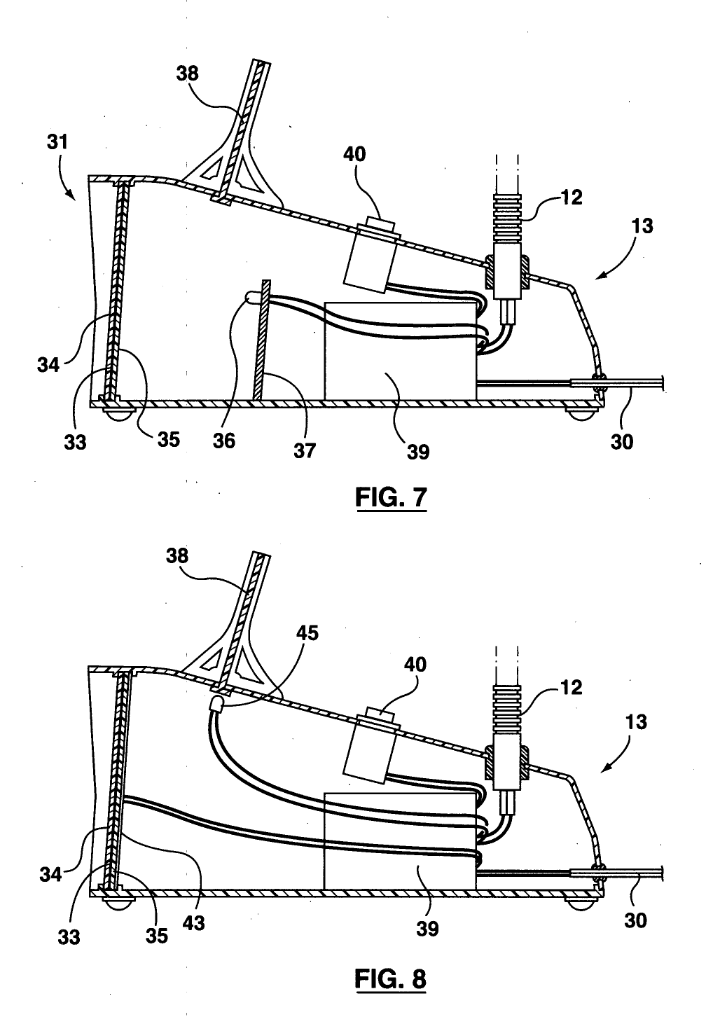

In the preferred embodiment where the lighting fixture comprises a desk lamp 10, a base 13 is provided with the simulated aircraft 11 illustrated in FIGS. 1 and 7, with a modification of base 13 seen in FIG. 8. A conventional electrical cord 30 supplies power to the electrical components within the base 13, as well as—through wires not shown—the light sources 15-19 associated with the simulated aircraft 11.

In a preferred embodiment of the invention, a major face 31 of the base 13 simulates a back-lit cockpit of the instrument panel in a real cockpit corresponding to the simulated aircraft 11. Surface 31 is provided by an image printed on a translucent white plastic sheet 33 sandwiched between two conventional lenses 34, 35 with the back-lighting provided by a small light emitting diode 36 mounted by a support 37 within the base 13. Additionally, a “heads up display” 38 may also be provided. The light emitting diode 36 has an open volume between it, the lens 35, and the heads-up display 38, so that the single diode 36 provides light both for the heads-up display 38 and to back-light the printed sheet 33.

As earlier indicated, the printing on the translucent sheet 33 simulates components of a real cockpit instrument panel. The simulated components may be provided by indicia simulating switches, instruments, gauges, joysticks, dials, screens, or other components typically provided in an aircraft cockpit.

The base 13 typically has located therein a transformer/light emitting diode driver 39, and electrical switch 40, as well as all necessary electrical wires for connecting all of the components of the entire lighting fixture 10 together. The electrical switch 40 may comprise any conventional switch, such as a plurality of pushbutton actuators, a single rocker switch, a rotary switch, or the like. In one embodiment, the switch 40 has a first position in which all of the primary and secondary light sources and the LED 36 are “off”, a second position in which the primary and all the secondary light sources and the LED 36 are “on”, a third position in which just the secondary light sources and the LED 36 are “on”, and a fourth position in which just the LED 36 is “on”. Other arrangements may be provided.

FIG. 8 shows a modified form of lamp base 13 according to the present invention, where identical components to those in FIG. 7 are shown by identical reference numerals. In the FIG. 8 embodiment, back-lighting for the printed sheet 33 is provided by a conventional electroluminescent panel 43 (also known as an EL sheet, EL foil, or EL film), with the conventional wires 44 extending to and from it and the transformer 39. In the FIG. 8 embodiment, if they heads-up display 38 is provided, then a light emitting diode 45 will be mounted adjacent to the interior of the casing for the base 13 where the heads-up display 38 is located. The LED 45 then provides a light source for the heads up display 38.

As a further modification of the embodiments of FIGS. 7 & 8 a conventional digital photo frame may be provided as part of the base 13, providing the elements 33, 34 and 35 instead of the exemplary structures described above. In this way one viewing the base 13 could see the display of several photos of the relevant aircraft in action, or photos of various cockpits, instead of a single representation. The different digital photos would be stored on a digital media card, as at element 37 in FIG. 7, and show static photos in a slide show, or show a movie.

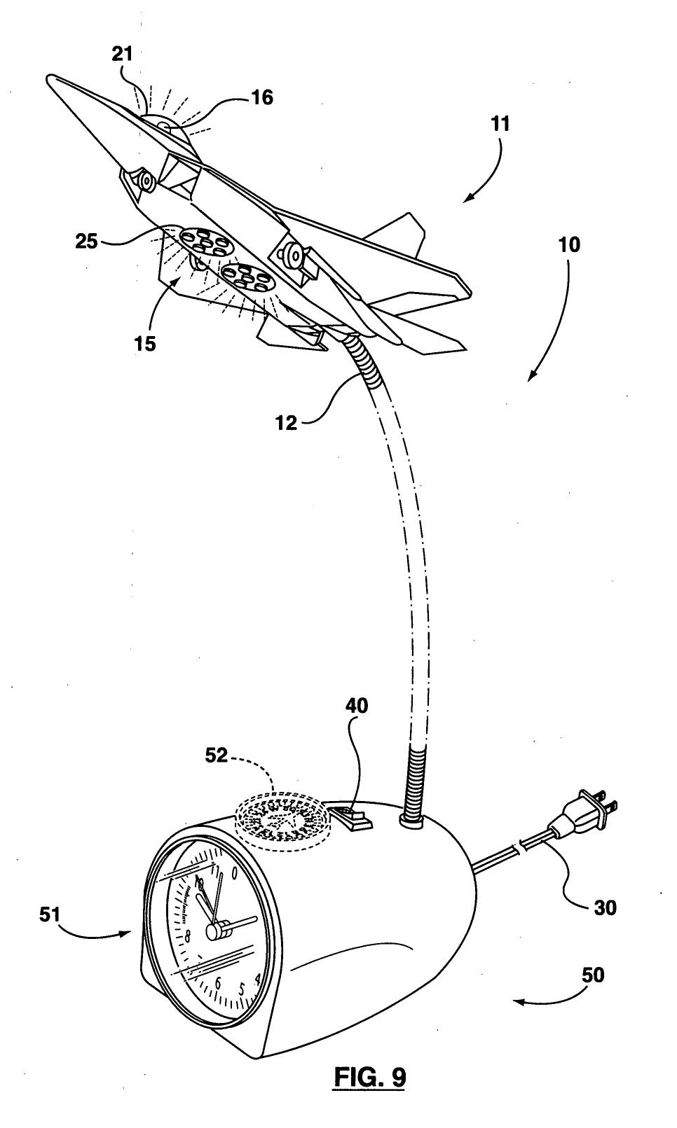

FIG. 9 shows a modification of the FIG. 1 embodiment in which the base 50 is substituted for the base 13. The base 50 is similar to the base 13 except that instead of the simulation of a cockpit or the like, it comprises at least one actual functioning instrument, in the embodiment actually illustrated, a clock 51 and—in dotted line—a compass 52. The instrument 51 may or may not be backlit, and may or may not have a heads up display, like 38 in FIGS. 7 & 8. The base 50 typically includes a switch 40 and electrical cord 30 and other necessary electrical components, like those of the FIGS. 7 & 8 embodiments.

While a single clock and a compass are illustrated in FIG. 9 as the instruments 51, 52, that illustration is exemplary only. A wide variety of instruments can be provided, either singly, in an instrument cluster, or different instruments viewable from different directions when looking at the base 50. For example, the at least one instrument 51 may be selected from one or more of a clock, barometer, thermometer, inclinometer, compass, and altimeter. For example, the compass 52 can be mounted generally horizontally on the top of the base 50, the clock 51 in the front, a thermometer on one side, and a barometer on another side.

While the invention has been herein shown and described in what is presently conceived to be the most practical and preferred embodiment thereof, it is apparent to those in the art that many modifications may be made, therefore the invention should be accorded the broadest interpretation possible to cover all equivalents.

What is claimed is:

1. A lighting fixture comprising a simulated aircraft having at least one primary light source which performs a volume lighting function, and at least one secondary light source which performs an aesthetic, educational, and/or nightlight function

2. A lighting fixture as recited in claim 1 wherein said simulated aircraft is primarily composed of plastic, and wherein said light sources are low-heat dissipating light sources.

3. A lighting fixture as recited in claim 2 wherein said light sources are light emitting diodes.

4. A lighting fixture as recited in claim 3 wherein said primary light source primarily emits a white light, and wherein at least one secondary light source emits a color other than white.

5. A lighting fixture as recited in claim 1 wherein said at least one secondary light source comprises a first secondary light source illuminating a simulated cockpit of said simulated aircraft, and a second secondary light source simulating a jet engine afterburner.

6. A lighting fixture as recited in claim 1 comprising a desk lamp; and wherein said simulated aircraft is connected by a support to a lamp base.

7. A lighting fixture as recited in claim 6 wherein said lamp base comprises back-lit indicia simulating an instrument panel of a cockpit of said simulated aircraft.

8. A lighting fixture as recited in claim 7 wherein backlighting for said cockpit-simulating indicia is provided by a light emitting diode or an electroluminescent panel, and wherein said backlighting performs a nightlight function.

9. A lighting fixture as recited in claim 7 wherein said base further comprises a heads-up display.

10. A lighting fixture as recited in claim 6 wherein said base includes an electrical switch controlling all light sources associated with the lighting fixture.

11. A lighting fixture as recited in claim 6 wherein said base comprises at least one actual functioning instrument.

12. A desk lamp comprising a simulated aircraft having at least one primary light source which performs a volume lighting function, a lamp base, and a support operatively connecting said lamp-base to said simulated aircraft, electrical power for lighting said at least one primary light source being provided from said lamp base through said support to said simulated aircraft.

13. A desk lamp as recited in claim 12 wherein said lamp base comprises back-lit indicia simulating an instrument panel in a cockpit of said simulated aircraft.

14. A desk lamp as recited in claim 13 wherein backlighting for said cockpit-simulating indicia is provided by a light emitting diode or an electroluminescent panel.

15. A desk lamp as recited in claim 14 wherein said backlighting performs a nightlight function.

16. A desk lamp as recited in claim 13 wherein said base further comprises a heads-up display, and wherein said base includes an electrical switch controlling all light sources associated with the desk lamp.

17. A desk lamp as recited in claim 12 wherein said base comprises at least two actual functioning instruments.

18. A lighting fixture as recited in claim 1 wherein said simulated aircraft comprises a simulation of a real military jet, commercial jet, helicopter, propeller plane, or unmanned military aircraft.

19. A lighting fixture as recited in claim 1 further comprising a heat sink comprising a piece of material substantially concentric with said primary light source.

20. A desk lamp as recited in claim 12 wherein said base comprises a digital photo frame which can display a number of different digital photos viewable when viewing said base.
